(19) United States
(12) Patent Application Publication
(10) Pub. No.: US 2013/0346981 A1
(43) Pub. Date: Dec. 26, 2013

(54) TASK MANAGEMENT APPLICATION FOR MOBILE DEVICES

(71) Applicants: Brian Johnson, San Francisco, CA (US); George Arriola, San Francisco, CA (US); Michael Bauerly, San Francisco, CA (US)

(72) Inventors: Brian Johnson, San Francisco, CA (US); George Arriola, San Francisco, CA (US); Michael Bauerly, San Francisco, CA (US)

(73) Assignees: SONY NETWORK ENTERTAINMENT INTERNATIONAL LLC, Los Angeles, CA (US); SONY CORPORATION OF AMERICA, San Diego, CA (US)

(21) Appl. No.: 13/529,420

(22) Filed: Jun. 21, 2012

(51) Int. Cl. G06F 9/46

(52) U.S. Cl. 718/100

(57) ABSTRACT

A task management application allows a user to organize tasks and display tasks to be completed by the user. In particular, the task management application allows a user to create a new task from a first application separate from the task management application, and provide information regarding the task to be completed. In addition, reference content is selected form the first application and included as part of the created task. The task, along with reference content selected from the first application, is displayed to the user for review.

### CROSS-REFERENCE TO RELATED APPLICATION(S)

This is a non-provisional of U.S. provisional application Ser. No. 61/571,111, entitled “GeoFencing,” filed Jun. 20, 2011 by Brian Johnson, Mike Bauerly, and George Arriola. U.S. provisional application Ser. No. 61/571,111 is hereby incorporated by reference in its entirety.

### BACKGROUND

The present invention is related to mobile devices, and in particular to task management applications for use on mobile devices.

A mobile device refers generally to small, hand-held computing devices such as smartphones and/or tablets. The mobile device includes communication (e.g., cellular, wireless) capabilities that allow it to access information online, and processing capabilities sufficient to allow it to run an operating system and applications. The applications take advantage of the capabilities of the mobile device (e.g., Internet access, local processing, etc.) to provide specific functionality to the user. In this way, a user selects those applications that are useful for download and storage.

### SUMMARY

A task management application allows a user to organize tasks and display tasks to be completed by the user. In particular, the task management application allows a user to create a new task from a first application separate from the task management application, and provide information regarding the task to be completed. In addition, reference content is selected from the first application and included as part of the created task. The task, along with reference content selected from the first application, is displayed to the user for review.

### BRIEF DESCRIPTION OF THE DRAWINGS

FIG. 1 is a functional block diagram of a mobile device according to an embodiment of the present invention.

FIG. 2 is a functional block diagram illustrating task creation and task surfacing between the task management application and other applications according to an embodiment of the present invention.

FIG. 3 is a block diagram illustrating an organization structure for information collected by the task management application according to an embodiment of the present invention.

FIGS. 4A-4C are screenshots illustrating task creation in the task management application according to an embodiment of the present invention.

FIGS. 5A-5C are screenshots illustrating task creation from an email application according to an embodiment of the present invention.

FIGS. 6A-6C are screenshots illustrating task creation from a map application according to an embodiment of the present invention.

FIGS. 7A-7C are screenshots illustrating task creation from a phone application according to an embodiment of the present invention.

FIGS. 8A-8C are screenshots illustrating task selection and completion according to an embodiment of the present invention.

FIGS. 9A-9D are screenshots illustrating task surfacing based on a location-based alert according to an embodiment of the present invention.

FIG. 10 is a screenshot illustrating location-based alerts generated with respect to tasks and users according to an embodiment of the present invention.

### DETAILED DESCRIPTION

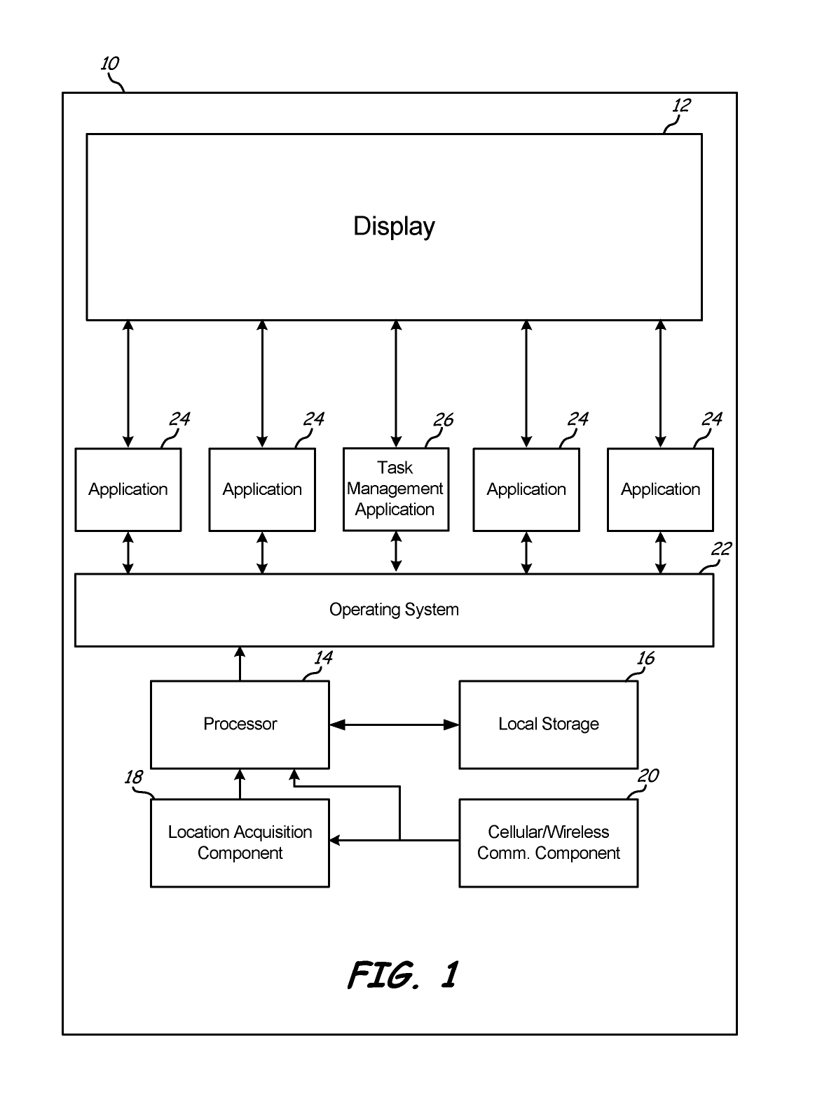

FIG. 1 is a functional block diagram of mobile device 10 according to an embodiment of the present invention. Mobile device 10 is a hand-held or mobile operating device, such as a smartphone or tablet. In the embodiment shown in FIG. 1, mobile device 10 includes hardware components such as display 12, processor 14, local storage 16, location acquisition component 18, and cellular/wireless communication component 20. Hardware components associated with mobile device 10 support execution of operating system 22, one or more application programming interfaces (APIs or “applications”) 24, and task management application 26.

Location acquisition component 18 acquires location information regarding the present location of mobile device 10. In one embodiment, location acquisition component 18 utilizes global positioning system (GPS) technology and/or information provided by cellular/wireless communication component 20 to acquire location information. Location acquisition via GPS requires communication with one or more positioning satellites, and therefore operates well outdoors. Location acquisition via information supplied by cellular/wireless communication component 20 is based on triangulation of available cellular towers and/or wireless networks and may be used along or in conjunction with GPS based location acquisition. Location acquisition information is provided to processor 14 for utilization by any of the plurality of applications 24 and/or task management application 26.

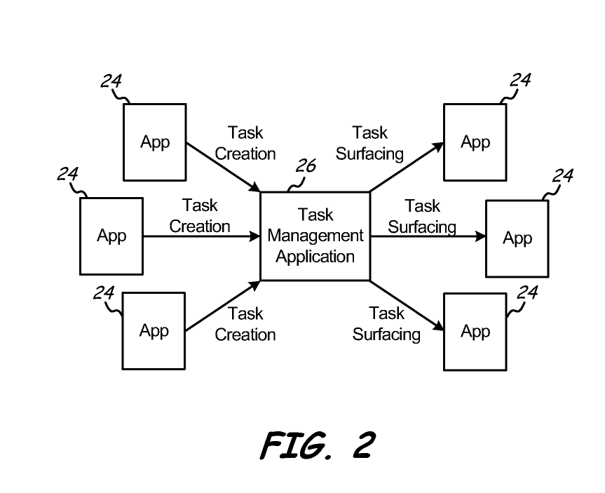

Operating system 22 provides a platform for executing applications 24 and task management application 26, providing a framework in which information is communicated from components such as location acquisition component 18 and cellular/wireless communication component 20 to each of the plurality of applications 24, as well as between the one or more applications themselves. For example, applications 24 and task management application 26 are capable of accessing information stored locally on mobile device 10 via local storage 16, as well as information stored remotely (i.e., on a remote server, not shown) accessed via cellular/wireless communication component 20. As described in more detail with respect to FIG. 2 below, task management application 26 may be accessed via one or more other applications 24 for the purpose of task creation, and may access one or more other applications 24 for the purpose of surfacing tasks. Applications 24 may include any number of applications, such as an electronic mail application, a map application, a phone application and/or other well known applications.

In one embodiment, display 12 is a touchscreen device that both displays information provided by the one or more applications 24 and/or task management application 26 and receives input from the user. In embodiments in which display 12 is not a touchscreen, a separate input device (e.g., keyboard, keypad, etc.) may be provided with mobile device 10.

FIG. 2 is a functional block diagram illustrating task creation and task surfacing between task management application 26 and other applications 24 according to an embodiment of the present invention. As discussed with respect to FIG. 1, task management application 26 is capable of communicating with other applications 24. The communication between applications allows task creation and task surfacing via other applications. With respect to task creation, a user operating in application 24 is able to create a new task in task management application 26 separate from or without the task management application being active. In particular, task creation allows content from application 24 to be provided for inclusion in the created task. Likewise, task management application 26 is able to surface tasks via alerts or other notifications in applications 24, alerting a user working in that particular application of the surfaced task.

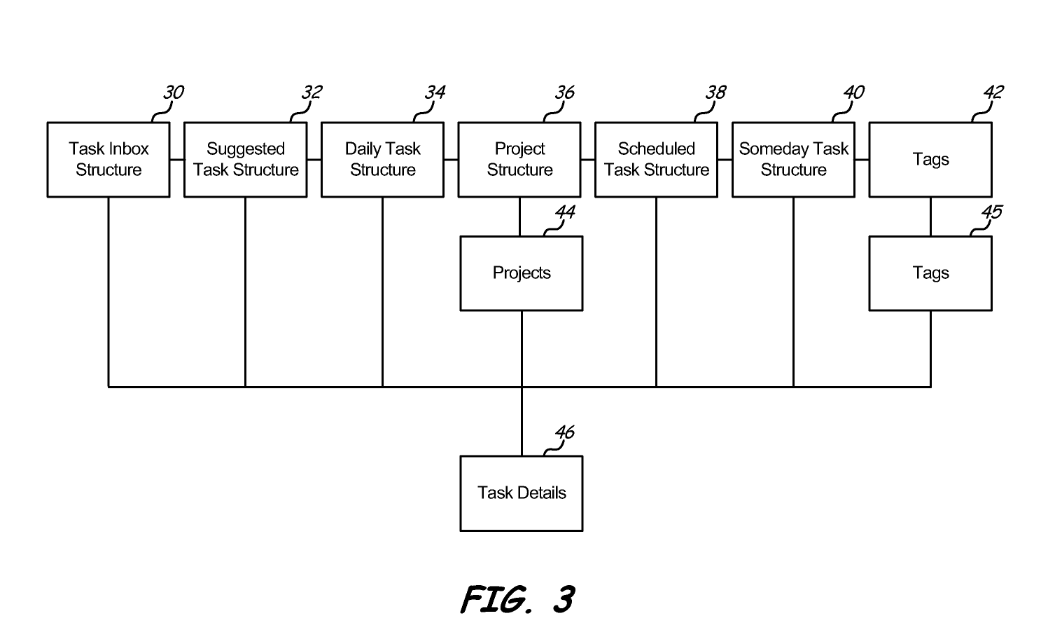

FIG. 3 is a block diagram illustrating an organization structure for information collected by task management application 26 and presented to a user according to an embodiment of the present invention. The organization structure is comprised of a plurality of top-level functional structures (e.g., inbox 30, suggested tasks 32, etc.) displayed to a user, each having different criteria for selecting and presenting tasks to a user. The structures may maintain their own criteria, or task management application 26 may maintain criteria for each structure and provide an indication of the tasks to be assigned to each structure. Selection of one of the functional structures results in tasks associated with that structure (i.e., tasks meeting the criteria of the structure) being displayed by the user for review, or secondary levels of functional structures (e.g., projects 44, tags 46) being displayed for review and selection by the user. Functional structures are capable of receiving input from external structures (e.g., location acquisition structure 18 shown in FIG. 1) to dynamically modify the tasks selected and presented to a user with respect to each structure.

The organization structure illustrated in FIG. 3 provides a tool for organizing the display and/or surfacing of tasks to a user based on different criteria. The organization structure illustrated in FIG. 3 includes task inbox structure 30, suggested task structure 32, daily task structure 34, project structure 36, scheduled task structure 38, someday task structure 40, and tag description structure 42. Each of the structures may be displayed to the user for selection. In response to selection of a particular structure, additional levels of hierarchy such as project 44 or tags 45, or a plurality of tasks 46 meeting the criteria of the selected task structure are displayed to the user.

Task inbox structure 30 organizes and displays those tasks that have not been previously organized or categorized. Selection of the task inbox structure 30 by a user results in those unorganized/uncategorized tasks being displayed to the user for review and manual organization.

Suggested task structure 32 displays a list of tasks suggested for completion based on an input received by suggested task structure 32 that indicates desired completion of the task. For example, in one embodiment suggested task structure 32 receives input from location acquisition structure 18 indicating the location of mobile device 10. Suggested task structure 32 compares the received location to stored locations associated with tasks to be completed. If the current location is within a particular radius or defined region associated with a particular task, that task is selected for display by suggested task structure 32. For example, a user may create a task named “pick-up dry cleaning” that is associated with the location of the dry cleaner. When the location of mobile device 10 is within a certain distance of the dry cleaner, suggested task structure 32 includes the task “pick up dry cleaning” in tasks returned by suggested task structure 32. Suggested task structure 32 may use other criteria, such as deadlines associated with each task to select tasks for display. In addition, suggested task structure 32 may use more than one criteria for displaying suggested tasks. For example, a task designated “Return Library Book” may be selected by suggested task structure 32 based on either location (i.e., when mobile device 10 is close to the library) or time (i.e., the day the library book is due back).

Daily task structure 34 displays those tasks scheduled for completion on today's date. Daily task structure 34 may also display those uncompleted tasks that are overdue. Daily task structure 34 receives a date input (e.g., today's date) to determine those tasks to display.

Projects structure 36 maintains and displays to a user a list of projects 44. A user may associate one or more tasks with respect to each project. For example, a user may create a project titled “Birthday Party”, and then associate a number of individual tasks with the project, such as “Pick up Ballons”, and “Buy Present”. In this way, a user is able to view all pending projects via project structure 36, and is able to select a particular project to view only those tasks associated with that project. However, that is not to say that those tasks may only be displayed or surfaced with respect to project structure 36. Rather, these tasks may also be displayed or surfaced via other structures, such as suggested structure 32 based on location input.

Scheduled task structure 38 maintains and displays tasks organized according to due date. In one embodiment, scheduled task structure 38 displays tasks based on the due date of the task. Similarly, someday task structure 40 maintains and display unscheduled tasks organized by the date of creation of the task. When displaying all unscheduled tasks (or someday tasks), someday task structure 40 may display the date of task creation to the user, or may display some other useful metric, such as elapsed time since task creation.

Tag structure 42 maintains and displays to user a list of tags 46. A user may associated one or more tasks with each tag. For example, a user may create a tag for “work”, and another tag for “home”. Tasks created by the user can be associated with either a “work” tag or a “home” tag, allowing a user to quickly locate all tasks associated with a particular tag. Tags allow a user to organize tasks based on different roles of the user. For example, tags allow a user to associate some tasks with work and others with home. To view all tasks associated with work, the user selects tag structure 42, and then the work tag from available tags 46.

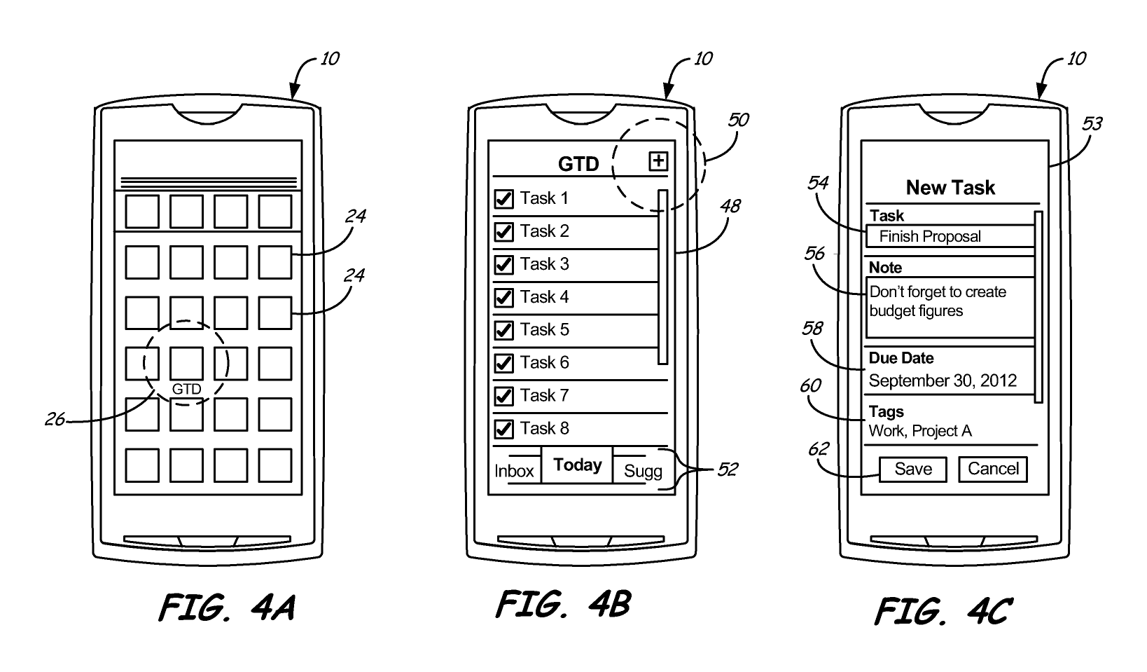

FIGS. 4A-4C are screenshots illustrating task creation in task management application 26 according to an embodiment of the present invention. FIG. 4A is a screenshot of mobile device 10 illustrating an application tray in which icons representing a plurality of applications 24 are displayed along with an icon representing task management application 26. A user is able to open task management application 26 by clicking or selecting the icon.

FIG. 4B is a screenshot of mobile device 10 illustrating home or start page 48 of task management application 26. To create a new task, a user clicks or selects add task icon (+) 50 shown at the top right portion of the display. In the embodiment shown in FIG. 4B, homepage 48 defaults to today task structure 34 (shown in FIG. 3), in which those tasks due today are displayed to the user. In other embodiments, homepage 48 may default to some other criteria for displaying tasks, such as suggested tasks provided by suggested task structure 32 (shown in FIG. 3). Other task management structures (discussed with respect to FIG. 3) are displayed along the bottom via menu portion 52, allowing a user to view tasks according to various criteria.

FIG. 4C is a screenshot of mobile device 10 illustrating task creation page 53 displayed after a user clicks the “add task” icon 50 shown in FIG. 4B. Task creation page 53 allows a user to enter information via task title input 54, notes input 56, due date input 58, and tags input 60. Once all information has been entered, a user saves the task by clicking save button 62. Information such as scheduled due date, tags, etc. will be utilized by task structures in organizing and displaying tasks to the user.

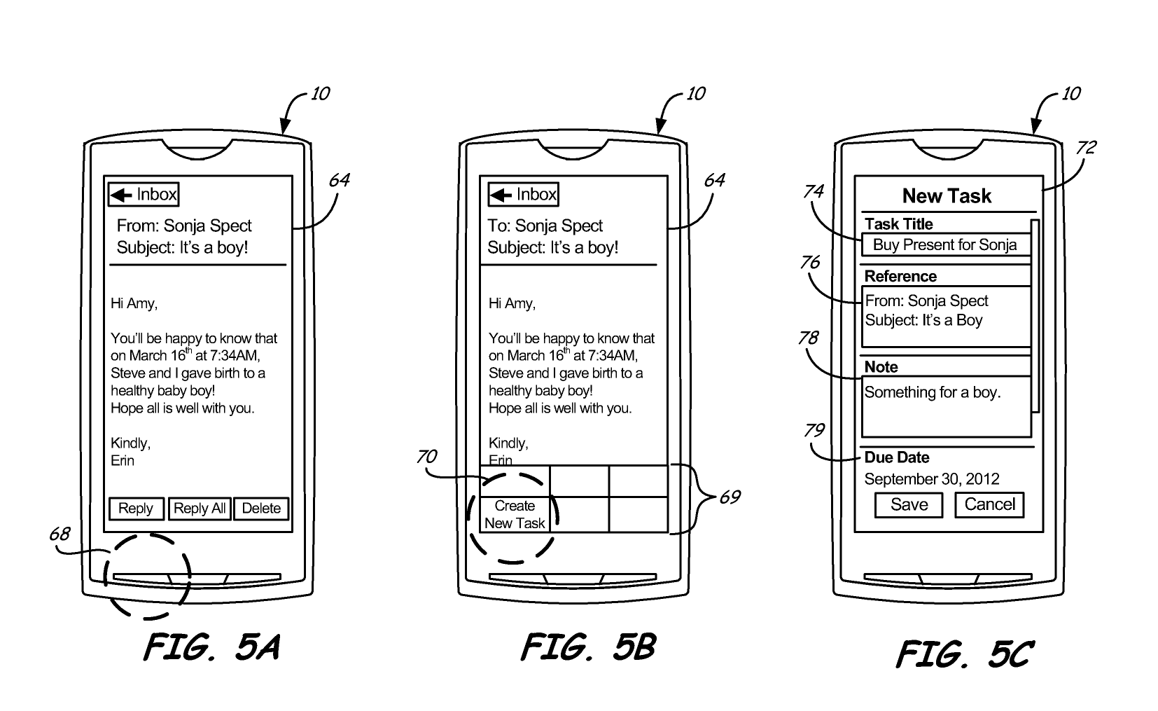

FIGS. 5A-5C are screenshots illustrating task creation from email application 64 according to an embodiment of the present invention. As described with respect to FIG. 2, tasks may be created via other applications 24. FIG. 5A is a screenshot of mobile device 10 illustrating creation of a new task from email application 64. To create a new task based on the email being viewed, the user selects menu button 68 to open a menu tab (shown in FIG. 5B).

In FIG. 5B, menu 69 is displayed, including create new task button 70. A user selects/clicks create new task button 70 to create a new task via task management application 26.

FIG. 5C is a screenshot of mobile device 10 illustrating task creation page 72 displayed by task management application 26 after a user clicks create new task button 70. Task creation page 72 allows a user to enter information via task title input 74, notes input 78, and due date input 79. In addition, task creation page 72 includes reference content input 76 that stores an image and/or text associated with the application used to create the task. For example, in the embodiment shown in FIG. 5C, reference content includes header information from the email being read when the user selected create new task button 70. In the embodiment shown in FIG. 5C, an image corresponding to the email header information is automatically selected as reference content. In other embodiments, a user may be allowed to select particular content from email application 64 to include as reference content. For example, a user may highlight a portion of email application 64 displayed prior to clicking create new task button 70, wherein the portion of the application highlighted by the user is selected as the reference content imported into reference content input 76. In another embodiment in which a user manually selects reference content, a user may click on reference content input 76, and be provided with a screen shot of email application 64 for the user to review and select a relevant portion of which to include as reference content input 76.

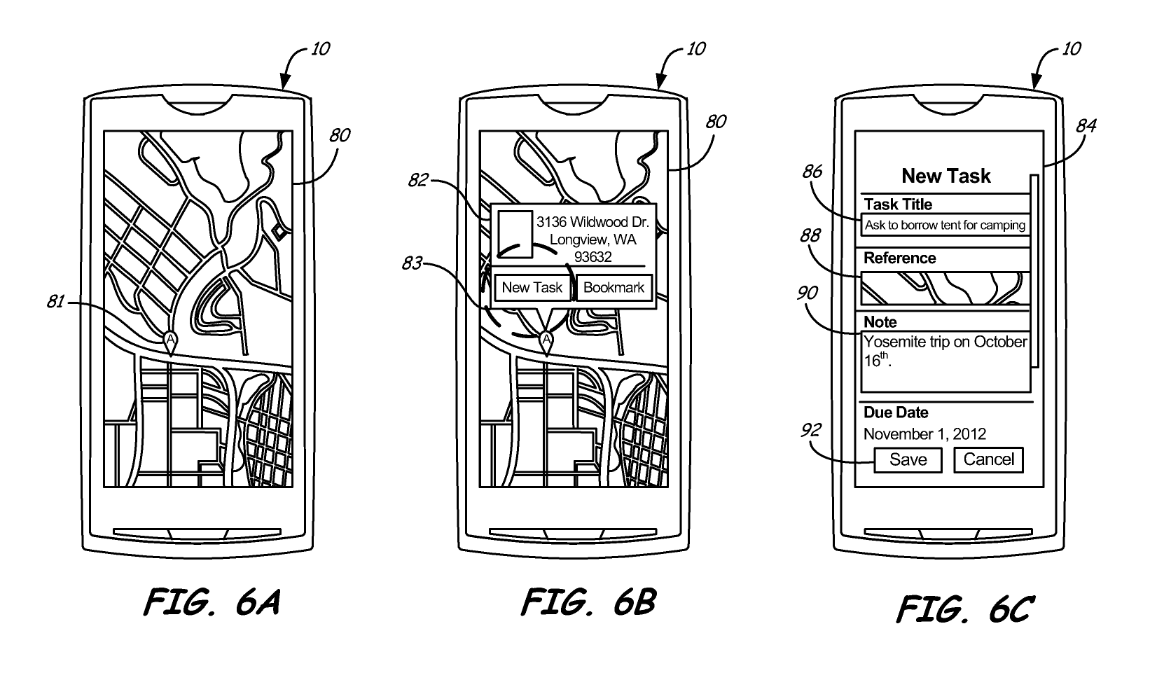

FIGS. 6A-6C are screenshots illustrating task creation from map application 80 according to an embodiment of the present invention. FIG. 6A is a screenshot of mobile device 10 illustrating map application 80, from which a new task is created. To create a new task based on a map location being viewed, the user selects a particular location 81 displayed on the map.

In FIG. 6B, pop-up window 82 opens in response to a user selecting a location in map application 80. In the embodiment shown in FIG. 6B, pop-up window 82 displays information about the location selected, including new task button 83 that allows the user to create a new task from map application 80 based on the selected location.

FIG. 6C is a screenshot of mobile device 10 illustrating task creation page 84 displayed after a user clicks new task button 83. Task creation page 84 allows a user to enter information via task title input 86, notes input 90, and due date input 92. In addition, task creation page 84 includes reference content input 88 that stores an image and/or text associated with map application 80 used to create the task. For example, in the embodiment shown in FIG. 6C, reference content includes a map image from the location selected/highlighted in map application 80 when the user clicked new task button 83 (shown in FIG. 6B). The map image is automatically selected for inclusion in reference content input 88. In other embodiments, a user may be allowed to select particular content from the application used to create the new task with which to include as reference content input. In still other embodiments, a user selects reference content input 88, and is provided with a screen shot of map application 80 for the user to review and select a relevant portion of which to include as reference content input 88. The task is saved by clicking save button 92.

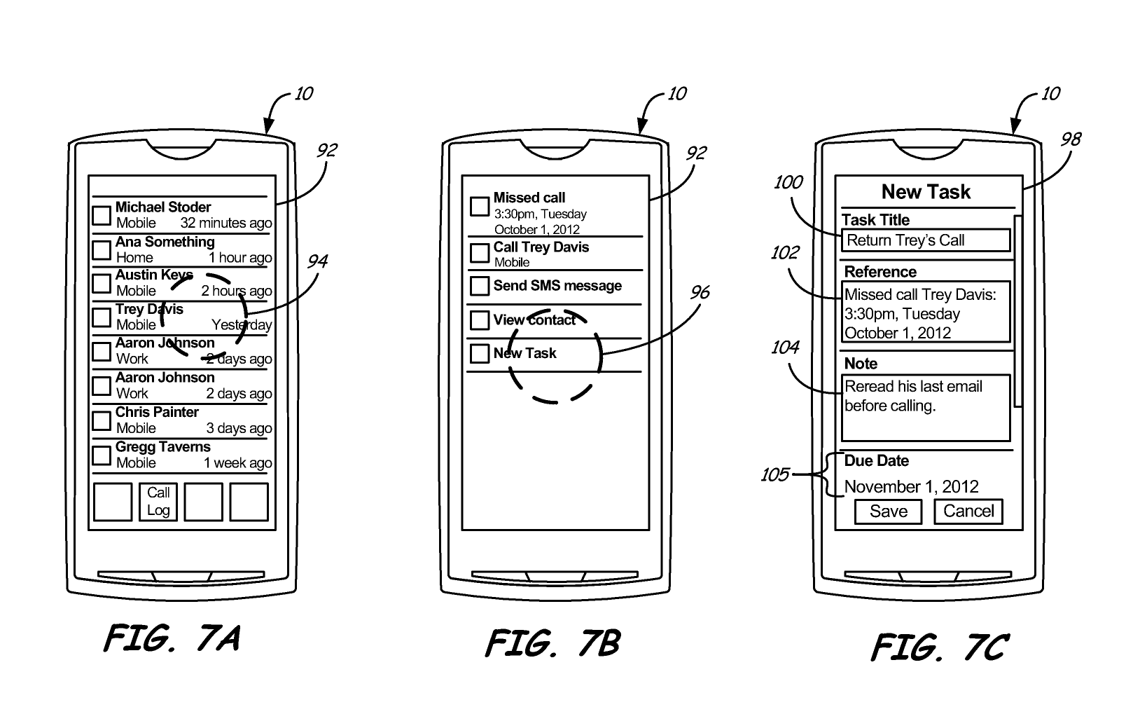

FIGS. 7A-7C are screenshots illustrating task creation from phone application 92 according to an embodiment of the present invention. In the embodiment shown in FIG. 7A, a user reviews a phone log of incoming/outgoing phone calls via phone application 92. A user selects one of the listed calls (e.g., missed call 94) to retrieve additional information regarding the call, as shown in FIG. 7B.

In FIG. 7B, additional information is displayed to the user regarding the phone call selected in FIG. 7A. For example, information may include the time of the call, duration, whether the call was a missed call, and options to call the person back. In addition, in the embodiment shown in FIG. 7B, the user may select new task button 96 to create a new task based on the selected incoming/outgoing phone call.

FIG. 7C is a screenshot of mobile device 10 illustrating task creation page 98 displayed after a user clicks new task button 96 shown in FIG. 7B. Task creation page 98 allows a user to enter information via task title input 100, notes input 104, and due date input 105. In addition, task creation page 98 includes reference content input 102 that stores an image and/or text associated with the application used to create the task. For example, in the embodiment shown in FIG. 7C, reference content includes information about the incoming/output call (e.g., person called, time of the call, etc.) being viewed when the user clicked new task button 96. In the embodiment shown in FIG. 7C, an image corresponding to call information illustrated in phone application 92 is automatically selected for inclusion in reference content input 102. In other embodiments, a user may be allowed to select particular content from the application used to create the new task with which to include as reference content input. For example, a user may highlight a portion of phone application 92 prior to clicking new task button 96, wherein the portion of the application highlighted by the user would be selected as the reference content imported into reference content input 102. In other embodiments in which a user manually selects reference content, a user clicks on reference content input 102, and is provided with a screen shot of phone application 92 for the user to review and select a relevant portion of which to include as reference content. In yet another embodiment, information associated with the missed call, although not necessarily information displayed in phone application 92 (as shown in FIG. 7B), may be selected for insertion into reference content 102. For example, in applications in which phone application 92 stores a picture associated with each phone/address book contact, that picture may be selected for insertion as reference content.

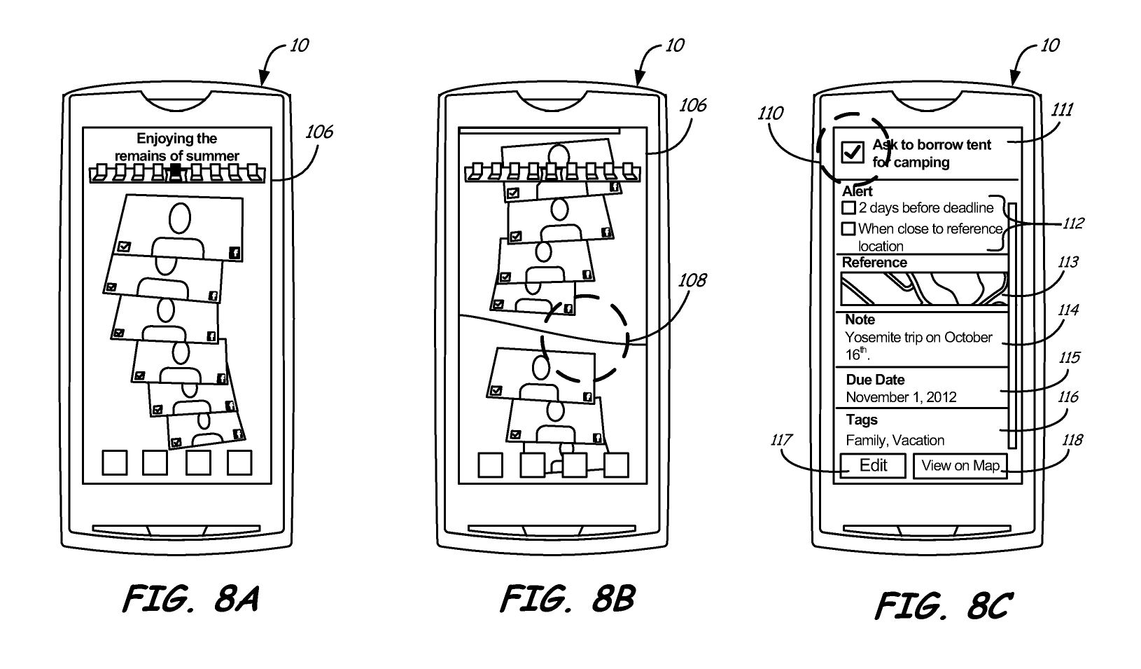

FIGS. 8A-8C are screenshots illustrating task selection and completion according to an embodiment of the present invention. In FIG. 8A, a user scrolls through TimeScape™ application 106, wherein tasks (and/or other notifications) are illustrated as tiles. In one embodiment, tiles are sequenced according to order of occurrence, which is particularly useful in displaying tasks to a user, wherein the due date of a task is used to order the task within the timeline. In FIG. 8B, a user clicks/selects a particular task 108 to view.

In FIG. 8C, task management application is opened and details regarding task 108 are displayed to the user. In the embodiment shown in FIG. 8C, details displayed to the user regarding the particular task being displayed include task completion checkbox 110, title portion 111, alerts portion 112, reference content portion 113, notes portion 114, due date portion 115, and tags portion 116. Task completion checkbox 110 indicates whether the task has been completed or not. Alerts portion 112 indicates those alerts that have been set for the task, and/or whether one or more of the alerts has been triggered. Reference content portion 113 displays reference content associated with the task. Notes portion 114 displays notes associated with the task, while due date portion 115 displays the task due date and tags portion 116 displays tags associated with the task. A user may edit the information entered via edit button 117. In addition, the user may open the application (to the extent one exist) used to create the task. In the example shown in FIG. 8C, the user can select/click view on map button 118 to open the map application for viewing the location associated with the task.

In FIG. 8C, a user may indicate that a task has been completed via checkbox 110. A user may also set reminders/alerts associated with the task via alert buttons 112. In the embodiment shown in FIG. 8C, a user may set a reminder/alert a certain period of time (e.g., two days) prior to the deadline for the task, or may set a location based alert (e.g., notification provided when close to a reference location). These alerts are employed by task management application 26 to surface tasks and are also employed by organizing structures described with respect to FIG. 3 to organize tasks for display (e.g., via suggested task structure 32, etc.).

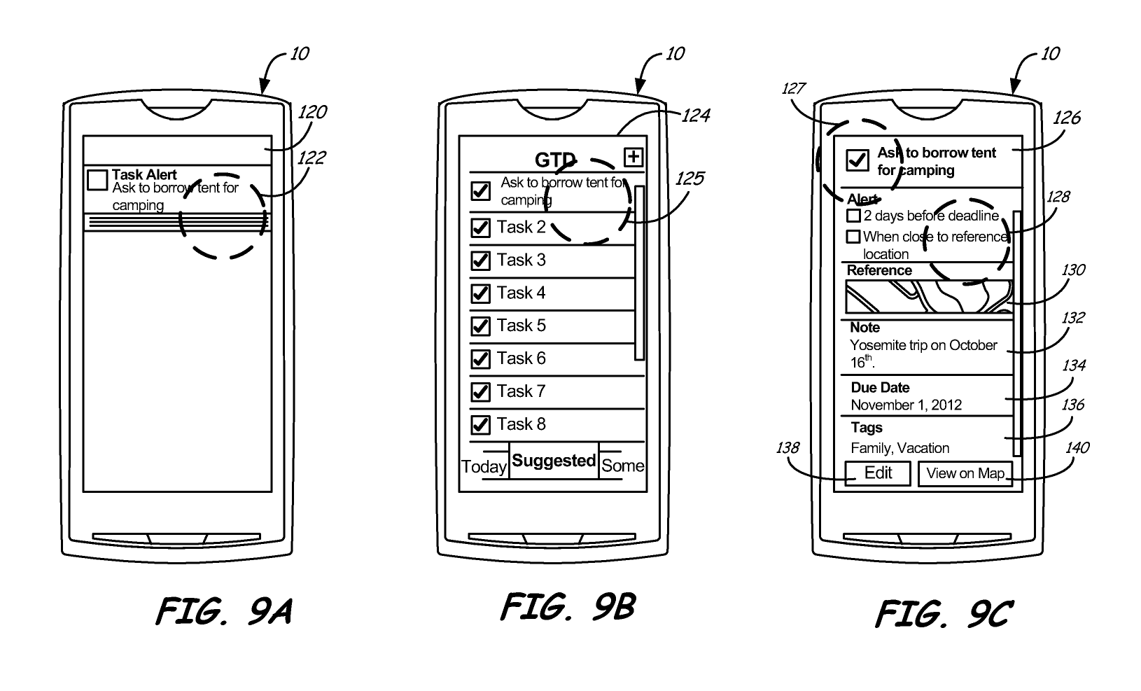

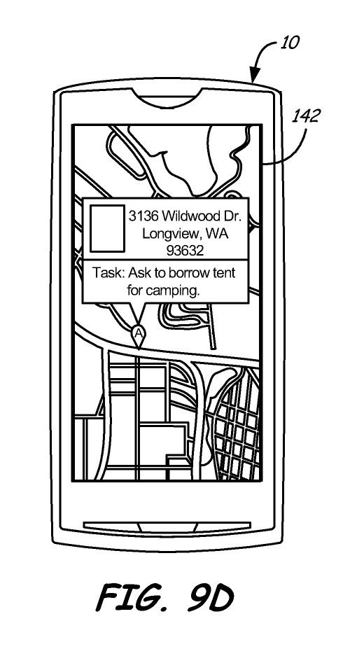

FIGS. 9A-9D are screenshots illustrating task surfacing based on a location-based alert according to an embodiment of the present invention. As discussed with respect to FIG. 8C, users are able to set location based alerts (along with other types of alerts, such as due date reminders, etc.). In general, task management application 26 compares location based information provided by location acquisition structure 18 (FIG. 1) to a location associated with a particular task. When mobile device 10 comes within a certain radius/distance of the location associated with a particular task, an alert is surfaced for the user.

In FIG. 9A, a user is viewing application 120, which may be an application other than task management application 26 or may be a home screen in which no applications are running. When mobile device 10 comes within a certain distance of a reference location, task alert 122 is surfaced in application 120. Once surfaced, a user can select the task to obtain/view additional information regarding the task, and/or to dismiss the task. Selecting the surfaced alert opens the task management application. In the embodiment shown in FIG. 9B, the task management application opens suggested task window 124, which orders tasks based on proximity to a location associated with each task and or due date of each task. Presumably, due to the nature of the alert, the task associated with the surfaced alert will be ordered at or near the top of task window 124. In other embodiments, only the surfaced task is displayed. In the embodiment shown in FIG. 9B, a user selects displayed task 125 to view additional details regarding the task to be completed.

In FIG. 9C, the task management application displays details regarding selected task 125. In the embodiment shown in FIG. 9C, details displayed to the user regarding the particular task being displayed include title portion 126, task completion checkbox 127, alerts portion 128, reference content portion 130, notes portion 132, due date portion 134, and tags portion 136. Task completion checkbox 127 indicates whether the task has been completed or not. Alerts portion 128 indicates those alerts that have been set for the task, and/or whether one or more of the alerts has been triggered. Reference content portion 130 displays reference content associated with the task. Notes portion 132 displays notes associated with the task, while due date portion 134 displays the task due date and tags portion 136 displays tags associated with the task. A user may edit the information entered via edit button 138. In addition, the user may open the application (to the extent one exist) used to create the task. In the example shown in FIG. 9C, the user can select/click view on map button 140 to open the map application for viewing the location associated with the task.

In the embodiment shown in FIG. 9C, alerts portion 128 indicates two alerts associated with the selected task, including “Two days before deadline” and “When close by reference location”. In this case, the surfaced alert was due to mobile device 10 coming within a defined distance of the reference location. This may be indicated in this view by changing the color of the alert labeled “When close by reference location”, or indicating in some other way that this alert has been triggered. In addition, the user is able to open the maps application by clicking/selecting the alert labeled “When close by reference location” in alerts section 128.

In FIG. 9D, map application 142 is opened in response to the user selecting the “when close by reference location” alert to illustrate the reference location associated with the task to be completed, as well as the user's current location as provided by location acquisition component 18 (FIG. 1). Map application 142 provides guidance to the user regarding reaching the reference location based on the user's current location.

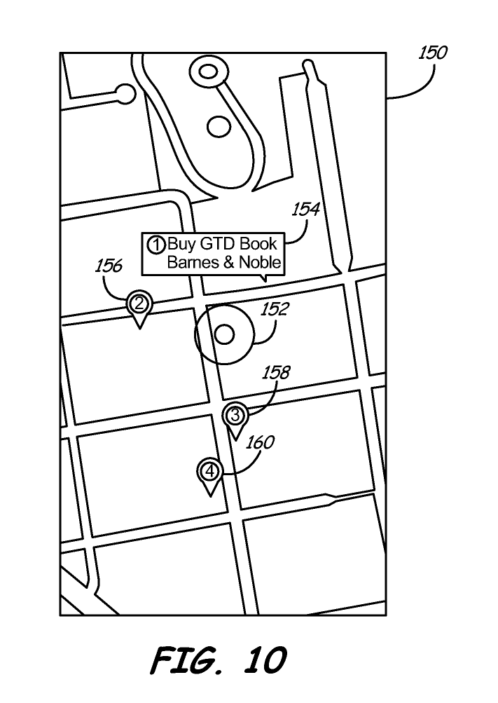

FIG. 10 is a screenshot of map application 150, which includes surfaces tasks displayed by location on the map. In the embodiment shown in FIG. 10, surfaced tasks include tasks 154, 156, 158, and 160. Surfaced task 154 is associated with a particular location (e.g., a bookstore), while tasks 156, 158 and 160 are associated with individuals. The embodiment shown in FIG. 10 illustrates that surfaced tasks (e.g., task alerts) may be generated with respect to a particular location as well as the location of a particular user, which may be received dynamically.

Furthermore, surfaced tasks 154, 156, 158 and 160 include a reference number corresponding to a suggested order of completing the tasks. The ordering is based on the results provided by suggested task structure (e.g., suggested task structure 32 shown in FIG. 3), and may be based on location proximity, due date, or a combination of both. In the embodiment shown in FIG. 10, surfaced task 154 is numbered ‘1’, surfaced task 156 is numbered ‘2’, surfaced task 158 is numbered ‘3’ and surfaced task 160 is numbered ‘4’. For example, a typical location based alert (e.g., pick up dry cleaning) is associated with the location of a particular dry cleaner business. However, task management application 26 also allows a user to set alerts associated with particular users, and will surface alerts when within a certain distance of that user.

The task management application of the present invention is therefore useful in creating and surfacing tasks in a meaningful way for users. In particular, users are allowed to create tasks from other applications, and include in the created task reference content selected from the other application. This reference content provides a useful visual reminder to the user regarding the task. Once created, tasks can be surfaced in other applications based on information such as the location of the mobile device operating the task management application and/or information regarding the due date of the tasks. The task management application also provides one or more useful structures for organizing and displaying created tasks to the user, including a suggested task structure that selects tasks for display to the user based on the current location of the user and/or on the due date of particular tasks.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A task management method employed on a mobile device, the method comprising:
creating a new task from a first application separate from a task management application;
receiving information from a user regarding the new task; and
displaying pending tasks to a user when a predetermined criteria is satisfied.

2. The method of claim 1, further including selecting reference content from the first application; and adding the selected reference content for inclusion with data associated with the new task.

3. The method of claim 2, wherein selecting reference content from the first application includes automatically selecting reference content from the first application.

4. The method of claim 2, wherein selecting reference content from the first application includes receiving input from a user regarding the reference content to be included from the first application.

5. The method of claim 2, wherein reference content from the first application includes an image associated with the first application.

6. The method of claim 2, wherein reference content from the first application includes text associated with the first application.

7. The method of claim 1, wherein receiving information from a user regarding the new task includes receiving location information associated with the task to be completed and a due data for task completion.

8. The method of claim 7, further including:
receiving location based information from a location acquisition structure of the mobile device regarding a present location of the mobile device;
comparing the location based information to location information associated with stored tasks; and
displaying a suggested list of tasks to be completed based on the comparison of the present location of the mobile device and location based information associated with the stored tasks.

9. A device for organizing and displaying tasks to a user, the device comprising:
a display for providing visual feedback to a user; and
a processor for executing applications associated with the device, including a task management application and at least one other application, wherein the at least one other application is operable to create a new task separate from the task management application by including the task information provided by the user, wherein the task management application displays the task to the user via the display when a predetermined criteria is satisfied.

10. The device of claim 9, wherein the task management application selects reference content automatically from the at least one other application for inclusion in the newly created task.

11. The device of claim 9, wherein the task management application receives input from a user regarding reference content selected from the at least one other application for inclusion in the newly created task.

12. The device of claim 9, wherein the reference content selected from the at least one other application is an image and/or text.

13. The device of claim 9, further including:
a location acquisition component that provides location based information to the task management application regarding a present location of the device, wherein the task management application selectively surfaces tasks based on proximity of the device to reference locations associated with created tasks.

14. The device of claim 13, wherein the task management application includes one or more functional structures defined by criteria for selecting and displaying tasks to a user.

15. The device of claim 14, wherein the one or more functional structures includes a suggested task list that selects tasks based, at least in part, on proximity of the device to reference locations associated with created tasks.

16. A task management display method employed on mobile devices, comprising:
creating a new task from a first application separate from a task management application;
receiving information from a user regarding the new task;
selecting reference content from the first application;
adding the selected reference content for inclusion with data associated with the new task; and
displaying pending tasks to the user.
